(19) United States
(12) Patent Application Publication
(10) Pub. No.: US 2018/0039817 A1
(43) Pub. Date: Feb. 8, 2018

(54) METHOD TO AUTHENTICATE OR IDENTIFY A USER BASED UPON FINGERPRINT SCANS

(71) Applicant: QUALCOMM Incorporated, San Diego, CA (US)

(72) Inventors: Maria Romera Jolliff, Vista, CA (US); Andrea Villa, San Diego, CA (US); Robert Tartz, San Marcos, CA (US); Jerry Chang, Carbondale, IL (US)

(21) Appl. No.: 15/230,012

(22) Filed: Aug. 5, 2016

(51) Int. Cl. G06K 9/00

(52) U.S. Cl. CPC G06K 9/00087; G06K 9/00026

(57) ABSTRACT

Aspects may relate to a device to authenticate a user that comprises a processor and a sensor. The processor coupled to the sensor may be configured to: receive at least one fingerprint scan from the sensor inputted by the user during an enrollment process to define a fingerprint password, the at least one fingerprint scan including one or more partial fingerprint scans from a same finger or different fingers of the user; and authenticates the user based upon the defined fingerprint password inputted through the sensor by the user.

### BACKGROUND

### Field

The present invention relates to a method to authenticate or identify a user based upon fingerprint scans.

### Relevant Background

Users of devices, such as, smartphones, tablets, Internet of Things (IoTs) devices, etc., are demanding increased security for proper authentication to perform different types of applications. This is especially true since many devices are performing applications related to: banking, commercial transactions, medical services, etc. User's want proper authentication to prove that they are indeed the authorized user and to prevent unauthorized users (hackers, thieves, etc.) from utilizing their device and/or applications. Passwords have typically been used for authentication purpose. Using a password has several potential drawbacks: 1) it may be cumbersome to enter a password (e.g., especially an alphanumeric password on a small keyboard); 2) a password may be forgotten; 3) a password may be observed by an unauthorized person and stolen; and 4) a password may be prone to brute-force guessing by an unauthorized person. Biometric inputs, such as, fingerprints, are increasingly being utilized as a suitable type of password for authentication purposes. However, conventional fingerprint techniques do not allow for utilizing different types of fingerprint inputs for different types of password strength for different types of applications or devices.

### SUMMARY

Aspects may relate to a device to authenticate a user that comprises a processor and a sensor. The processor coupled to the sensor may be configured to: receive at least one fingerprint scan from the sensor inputted by the user during an enrollment process to define a fingerprint password, the at least one fingerprint scan including one or more partial fingerprint scans from a same finger or different fingers of the user; and authenticate the user based upon the defined fingerprint password inputted through the sensor by the user.

### BRIEF DESCRIPTION OF THE DRAWINGS

FIG. 1 is a diagram of a system in which embodiments may be practiced.

FIG. 2 is a flow diagram of a process to authenticate a user.

FIG. 3 is a flow diagram of a process to enroll a user.

FIG. 4 is a flow diagram of a process for authenticating a user after enrollment.

FIG. 5 is a diagram of an example of multiple full fingerprint scans from multiple fingers in a particular time sequence.

FIG. 6 is a diagram of an example of a plurality of partial fingerprint scans in a particular time sequence using a single finger.

FIG. 7 is a diagram of an example of a unique spatial configuration of simultaneous full and partial fingerprint scans from multiple fingers.

FIG. 8 is a diagram of an example of a unique spatial configuration of simultaneous partial fingerprint scans from multiple fingers.

FIG. 9 is a diagram of an example of multiple unique spatial configurations of simultaneous full and partial fingerprint scans from multiple fingers in a particular time sequence.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

As used herein, the terms “device”, “computing device”, or “computing system”, may be used interchangeably and may refer to any form of computing device including but not limited to laptop computers, personal computers, tablets, smartphones, system-on-chip (SoC), televisions, home appliances, cellular telephones, watches, wearable devices, Internet of Things (IoT) devices, personal television devices, personal data assistants (PDA's), palm-top computers, wireless electronic mail receivers, multimedia Internet enabled cellular telephones, Global Positioning System (GPS) receivers, wireless gaming controllers, receivers within vehicles (e.g., automobiles), interactive game devices, notebooks, smartbooks, netbooks, mobile television devices, desktop computers, servers, access control devices (e.g., for locking/unlocking homes, vehicles, etc.), or any type of computing device or data processing apparatus.

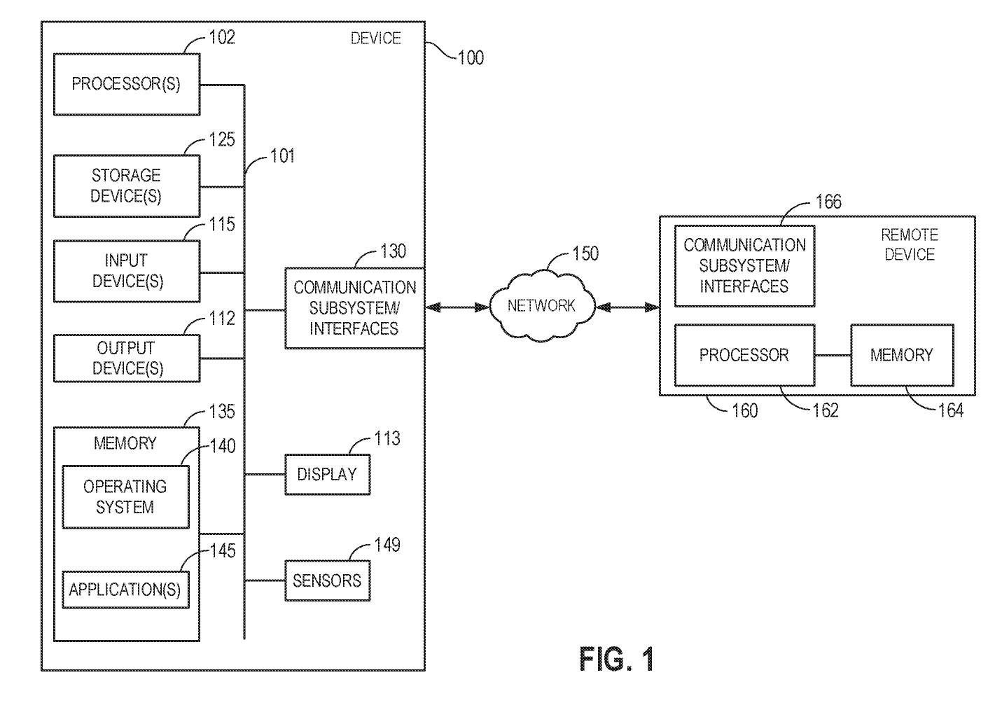

With reference to FIG. 1, an example device 100 may be in communication with one or more other remote devices 160, respectively, via a network 150. For example, remote device 160 may be a service provider (e.g., finance, commerce, medical, government, corporate, social networking, etc.) that provides services based on data exchanges with computing device 100 through the network 150.

As an example, device 100 may comprise hardware elements that can be electrically coupled via a bus 101 (or may otherwise be in communication, as appropriate). The hardware elements may include one or more processors 102, including without limitation one or more general-purpose processors and/or one or more special-purpose processors (such as secure processors, cryptoprocessors, digital signal processing chips, graphics acceleration processors, and/or the like); one or more input devices 115 (e.g., keyboard, keypad, mouse, etc.); and one or more output devices 112—such as a display device (e.g., screen) 113, speaker, etc. Additionally, device 100 may include a wide variety of sensors 149. Sensors may include: an ambient light sensor (ALS), a biometric sensor, an accelerometer, a gyroscope, a magnetometer, an orientation sensor, a fingerprint sensor, a weather sensor (e.g., temperature, wind, humidity, barometric pressure, etc.), a Global Positioning Sensor (GPS), an infrared (IR) sensor, a proximity sensor, near field communication (NFC) sensor, a microphone (e.g., for voice scans), a camera (e.g., for facial and/or eye scans), or any type of sensor. In one embodiment, as will be discussed in more detail hereafter, display 113 may be a display including a fingerprint scanner, as will be described in more detail hereafter.

Device 100 may further include (and/or be in communication with) one or more non-transitory storage devices or non-transitory memories 125, which can comprise, without limitation, local and/or network accessible storage, and/or can include, without limitation, a disk drive, a drive array, an optical storage device, flash memory, solid-state storage device such as appropriate types of random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

Device 100 may also include communication subsystems and/or interfaces 130, which may include without limitation a modem, a network card (wireless or wired), a wireless communication device and/or chipset (such as a Bluetooth device, an 802.11 device, a Wi-Fi device, a WiMax device, cellular communication devices, etc.), and/or the like. The communications subsystems and/or interfaces 130 may permit data to be exchanged with other remote devices 160 (e.g., service providers, etc.) through an appropriate network 150 (wireless and/or wired).

In some embodiments, device 100 may further comprise a working memory 135, which can include a RAM or ROM device, as described above. Device 100 may include firmware elements, software elements, shown as being currently located within the working memory 135, including an operating system 140, applications 145, device drivers, executable libraries, and/or other code. In one embodiment, an application may be designed to implement methods, and/or configure systems, to implement embodiments, as described herein. Merely by way of example, one or more procedures described with respect to the method(s) discussed below may be implemented as code and/or instructions executable by a device (and/or a processor within a device); in an aspect, then, such code and/or instructions can be used to configure and/or adapt a device 100 to perform one or more operations in accordance with the described methods, according to embodiments described herein, with respect to receiving fingerprint scans and authenticating users based upon defined fingerprint passwords, etc., as described herein.

A set of these instructions and/or code may be stored on a non-transitory computer-readable storage medium, such as the storage device(s) 125 described above. In some cases, the storage medium might be incorporated within a computer system, such as device 100. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by device 100 and/or might take the form of source and/or installable code, which, upon compilation and/or installation on device 100 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other computing devices such as network input/output devices may be employed.

As previously described, device 100 may be any type of device, computer, smartphone, tablet, cellular telephone, watch, wearable device, Internet of Things (IoT) device, or any type of computing device that can communicate with other devices 160 via a wired and/or wireless network 150. Further, as has been previously described, device 100 may be in communication via interface 130 through network 150 to a remote device 160. It should be appreciated that remote device 160 may be a computing device having at least a processor 162, a memory 164, an interface/communication subsystem 166, as well as other hardware and software components, to implement operations. For example, remote device 160 may be a particular type of service provider (e.g., finance, commerce, medical, government, corporate, social networking, etc.) that provides services based on data exchanges with device 100 through the network 150. It should be appreciated that device 100 and remote device 160 may be in communication through network 150 in a wireless, wired, or combination of wireless/wired fashion.

Embodiments may relate to utilizing fingerprints inputted by a user through a sensor 149, such as, a display 113 including a fingerprint scanner (hereafter referred to as sensor display 149), to define fingerprint passwords through an enrollment process that may have different “password strengths” and then utilizing these defined fingerprint passwords thereafter to authenticate the user. These types of fingerprint passwords may be used to overcome issues with spoofing—both through the use of fingerprints themselves and through a “combination lock” approach of using different types of fingerprint related entries, as will be described hereafter. Also, as will be described hereafter, these types of fingerprint entries selectable by a user during enrollment for fingerprint password definition allow users to choose different types of fingerprint passwords—easier fingerprint passwords for less secure applications 145 and more complex fingerprint passwords for more sensitive applications 145 that require more security.

Therefore, embodiments may allow a user of a device 100 to select the “password strength” desired for authentication, for example, to unlock a device 100 or an application 145. As an example, different levels of password strength, such as: low, medium, or high; may be defined and used by the user. As a particular example, this authentication may be to unlock a device 100 (e.g., a cellphone, a tablet, a car, the door of a building, etc.), but may also be used for authentication in the use of applications 145—such as: mobile banking, commercial transactions, purchasing products, authentication to use an application, etc. These authentication and unlocking techniques may be particularly used for Internet of Things devices—such as: doors of houses and buildings, cars, lights, meters, alarm systems, etc. As an example, the authentication and unlocking techniques may be used for access control devices (e.g., for locking/unlocking homes, vehicles, etc.).

In one embodiment, device 100 to authenticate a user may include: a sensor 149 and a processor 102 coupled to sensor 149. The processor 102 may be configured to: receive at least one fingerprint scan from the sensor 149 inputted by the user during an enrollment process to define a fingerprint password. The at least one fingerprint scan may include one or more partial fingerprint scans from a same finger or different fingers of the user. Further, processor 102 may be configured to authenticate the user based upon the defined fingerprint password inputted through the sensor 149 by the user to perform a function such as unlocking a device or authentication for an application 145 function.

In one embodiment, sensor 149 may be a display 113 including a fingerprint scanner such that the display 113 operates as a sensor to receive the fingerprint scans from the user. For example, the sensor display including the fingerprint scanner may be an optical sensor, an ultrasonic sensor, or a capacitance sensor. As an example, the display may be a touchscreen display or a regular display with which the fingerprint scanner is integrated such that the whole display accepts fingerprint scans. As another example, the fingerprint scanner may be independent of the touchscreen display or regular display. For example, the fingerprint scanner may be separate from the display in the housing of the device 100 under the display, above the display, on the sides of the housing, or on the backside of the housing. It should be appreciated that sensor 149 may be any suitable sort of sensor display to receive a fingerprint scan from a user via the display screen. Hereafter, this will be referred to as sensor display 149. However, it should be appreciated that any suitable sensor to receive a fingerprint scan may be utilized, either as part of the display or at another location of the device 100. Therefore, a suitable fingerprint sensor may be located at any location on the device 100.

In some embodiments, as will be described in more detail hereafter, the at least one or more fingerprint scans may be full fingerprint scans from a same finger or different fingers of the user. As an example, the full fingerprint scan may include a pad of the finger. As to partial fingerprint scans, the partial fingerprint scans may include at least one of a tip or a side of the finger (e.g., left side or right side). Further, for the full or partial fingerprint scans these scans may include a roll or an angle of the fingerprint. Moreover, the full or partial fingerprint scans from the same or different fingers may occur in a predefined order set by the user during the enrollment process. Additionally, the full or partial fingerprint scans may occur at the same time to simultaneously define a unique spatial configuration from multiple touching fingers. In one embodiment, multiple spatial configurations may be set by the user during the enrollment process in a predefined order to define the fingerprint password. Examples of these various embodiments will be described in more detail hereafter. It should be appreciated that all of these types of user defined full and/or partial fingerprint scans that include user defined sequential ordering and include user defined spatial configuration are defined by the user in the enrollment process to define the fingerprint password and the fingerprint password may be used thereafter by the user to authenticate the user for the use of an application or to unlock a device. Further, it should be appreciated, that the various user defined fingerprint passwords based on fingerprint scans received from the sensor display 149, and processed by processor 102, during enrollment, may be stored in memory 125. In this way, when the user enters a fingerprint password for authentication, under the control of processor 102, the entered fingerprint password may be compared against the stored fingerprint password, and if they match, the user is authenticated.

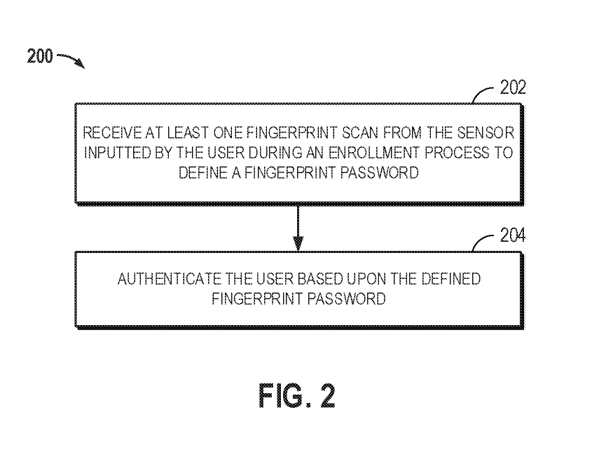

With brief additional reference to FIG. 2, a process 200 to authenticate a user will be described. At block 202, the process 200 receives at least one fingerprint scan from sensor display 149 inputted by the user during an enrollment process to define a fingerprint password. The at least one fingerprint scan may include one or more partial or full fingerprint scans from a same finger or different fingers of the user. At block 204, the user may be authenticated based upon the defined fingerprint password being inputted by the sensor display 149 by the user. For example, if a fingerprint password entered by the user matches a previously stored fingerprint password enrolled by the user, the user is authenticated for the use of an associated application or function.

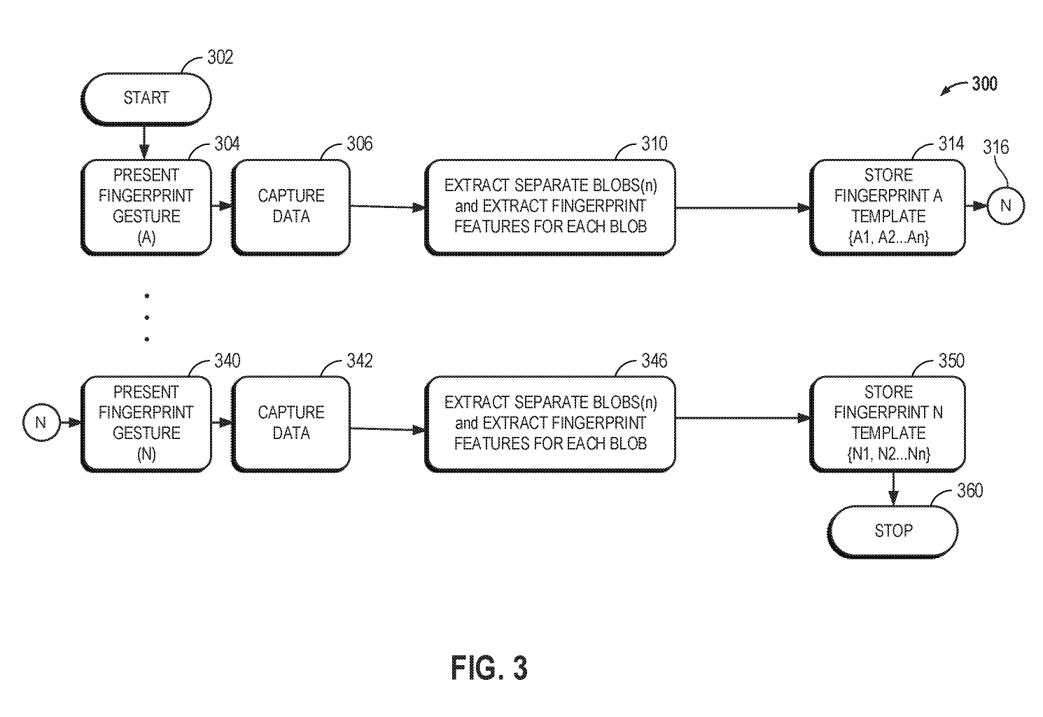

With additional reference to FIG. 3, a process 300 to enroll a user will be hereafter described. At block 302, the process starts. At block 304, present fingerprint gesture (A) is inputted by the user by placing fingerprint(s) upon the sensor display 149 that is read by sensor display 149. At block 306, the data is captured (e.g., full and/or partial fingerprint scan(s)). At block 310, the blob data of the fingerprint scan(s) is extracted (extract separate blobs(n)) and in particular the fingerprint features for each blob are extracted. It should be appreciated that each individual blob contains fingerprint features. First, the number of blobs is extracted. Then, for each blob, the fingerprint features are extracted. At block 314, the fingerprint scan template is stored in memory 125. It should be appreciated that fingerprint scan template A 314 may include multiple full and/or partial fingerprint scans (A1, A2 . . . An) separated spatially (e.g., a spatial configuration) or may only include one. Therefore, a single fingerprint scan (A1) may be present or multiple simultaneous fingerprint scans (An) may be present. If another fingerprint scan template is to be enrolled (as when creating a unique fingerprint sequence) circle N 316, the enrollment process continues. At block 340, present fingerprint gesture (N) is inputted by the user by placing fingerprint(s) upon the sensor display 149 that is read by sensor display 149. At block 342, the data is captured (e.g., full and/or partial fingerprint scan(s)). At block 346, the blob data of the fingerprint scan(s) is extracted (extract separate blobs(n)) and in particular the fingerprint features for each blob are extracted. It should be appreciated that each individual blob contains fingerprint features. First, the number of blobs is extracted. Then, for each blob, the fingerprint features are extracted. At block 350, the fingerprint scan template is stored in memory 125. The process may then stop 360 after enrollment is complete. It should be appreciated that fingerprint scan template N 350 may include multiple full and/or partial fingerprint scans (N1, N2 . . . Nn) separated spatially (e.g., a spatial configuration) or only include one. Therefore, a single fingerprint scan (N1) may be present or multiple simultaneous fingerprint scans (Nn) may be present.

In this way, fingerprint scans may be individual fingerprint scans (full or partial) or multiple fingerprint scans (full and/or partial) separated spatially (e.g., spatial configurations) and these types of fingerprint scans may be separated sequentially by time (e.g., multiple individual full and/or partial fingerprint scans separated in time as well as multiple spatial configurations separated in time). In other words, any number (A . . . N) of fingerprint scans may be enrolled and may later be authenticated as described below. Therefore, a unique “template combination” may be constructed during enrollment, such that: template combination=(A1, A2, . . . An+B1, B2, . . . Bn+N1, N2, . . . Nn)

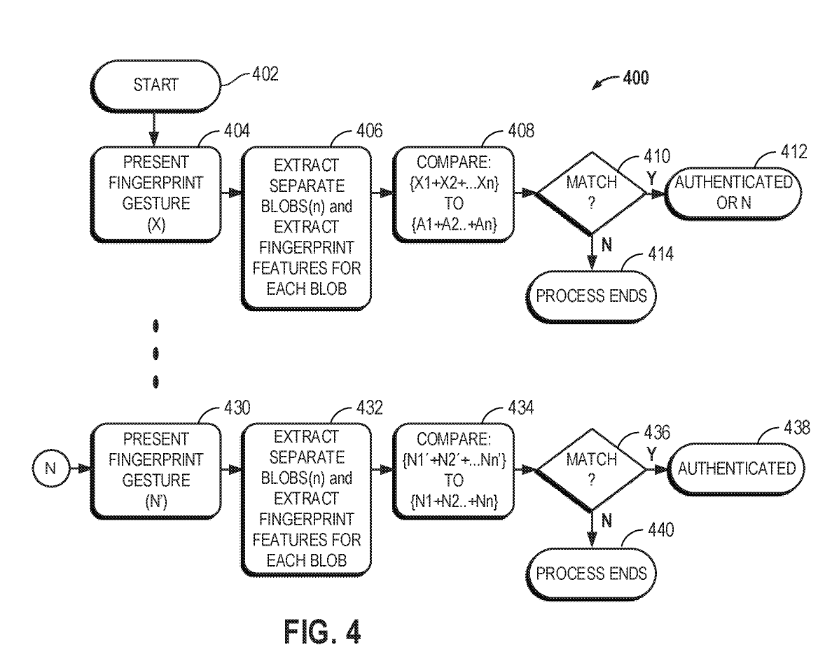

With additional reference to FIG. 4, a process 400 for matching the template combination to authenticate a user after enrollment is described. Process 400 starts at block 402. At block 404, present fingerprint gesture (X) is inputted by the user by placing fingerprint(s) upon the sensor display 149 that is read by sensor display 149. As before, the data is captured (e.g., full and/or partial fingerprint scan(s)). At block 406, the blob data of the fingerprint scan(s) is extracted (extract separate blobs(n)) and in particular the fingerprint features for each blob are extracted. It should be appreciated that each individual blob contains fingerprint features. First, the number of blobs is extracted. Then, for each blob, the fingerprint features are extracted. It should be appreciated that fingerprint scan data entered may include multiple full and/or partial fingerprint scans (X1, X2 . . . Xn) separated spatially (e.g., a spatial configuration) or may only include one. At block 408, the entered single or multiple full and/or partial fingerprint scans (X1, X2 . . . Xn) are compared against the previously enrolled single or multiple full and/or partial fingerprint scans (A1, A2 . . . An). At block 410, if the inputted fingerprint password (X1, X2 . . . Xn) matches the previously stored fingerprint password (A1, A2 . . . An) then the user is authenticated (block 412)—or if further fingerprint scans are required the process moves to block 412. If the fingerprint passwords do not match the process ends (block 414) and the fingerprint password is not authenticated.

Similarly, if further matching is required (block 412), at block 430, present fingerprint gesture (N′) is inputted by the user by placing fingerprint(s) upon the sensor display 149 that is read by sensor display 149. As before, the data is captured (e.g., full and/or partial fingerprint scan(s)). At block 432, the blob data of the fingerprint scan(s) is extracted (extract separate blobs(n)) and in particular the fingerprint features for each blob are extracted. It should be appreciated that each individual blob contains fingerprint features. First, the number of blobs is extracted. Then, for each blob, the fingerprint features are extracted. It should be appreciated that fingerprint scan data entered may include multiple full and/or partial fingerprint scans (N1′, N2′ . . . Nn′) separated spatially (e.g., a spatial configuration) or may only include one. At block 434, the entered single or multiple full and/or partial fingerprint scans (N1′, N2′ . . . Nn′) are compared against the previously enrolled single or multiple full and/or partial fingerprint scans (N1, N2 . . . Nn). At block 436, if the inputted fingerprint password (N1′, N2′ . . . Nn′) matches the previously stored fingerprint password (N1, N2 . . . Nn) then the user is authenticated (block 438). If the fingerprint passwords do not match the process ends (block 440) and the fingerprint password is not authenticated.

In this way, fingerprint passwords may be individual fingerprint scans (full or partial) or multiple fingerprint scans (full and/or partial) separated spatially (e.g., spatial configurations) and these types of fingerprint scans may be separated sequentially by time (e.g., multiple individual full and/or partial fingerprint scans separated in time as well as multiple spatial configurations separated in time), such that fingerprint passwords are provided that may be temporal and/or spatially defined that need to be matched in the exact same order for authentication providing a very strong authentication standard to authenticate applications and the unlocking/use of devices. It should be noted that every unique scan combination for all template segments must match in order for authentication to occur.

Particular examples of full and/or partial fingerprint scans and spatial configurations and sequential ordering thereof will be hereafter described.

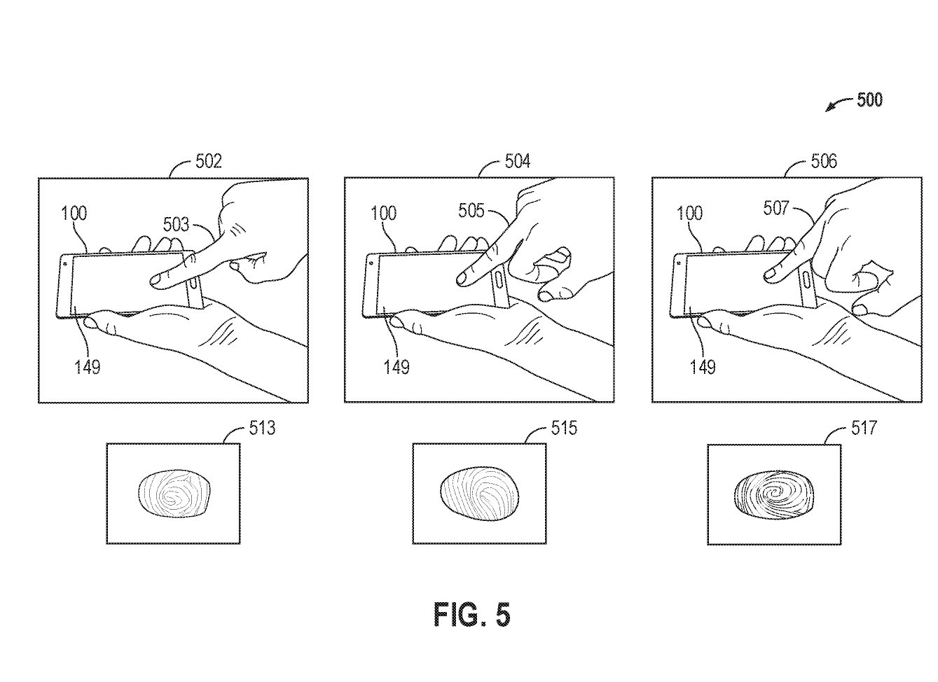

With additional reference to FIG. 5, an example 500, of multiple full fingerprint scans from multiple fingers in a particular time sequence is described. At step 502, a first full fingerprint scan is taken from a user's index finger 503 by the sensor display 149 of device 100. Based upon this, a full fingerprint scan (blob) 513 is received and fingerprint features are extracted and stored as a segment in the template. At step 504, a second full fingerprint scan is taken from a user's middle finger 505 by the sensor display 149 of device 100. Based upon this, a full fingerprint scan (blob) 515 is received and fingerprint features are extracted and stored as a segment in the template. At step 506, a third full fingerprint scan is taken from a user's ring finger 507 by the sensor display 149 of device 100. Based upon this, a full fingerprint scan (blob) 517 is received and fingerprint features are extracted and stored as a segment in the template. It should be appreciated that this multiple full fingerprint scan from multiple fingers in a particular time sequence may be used as a user defined fingerprint password that is enrolled by the user and that may be used to authenticate the user to utilize an application or device—if the entered fingerprint password matches the stored fingerprint password from enrollment.

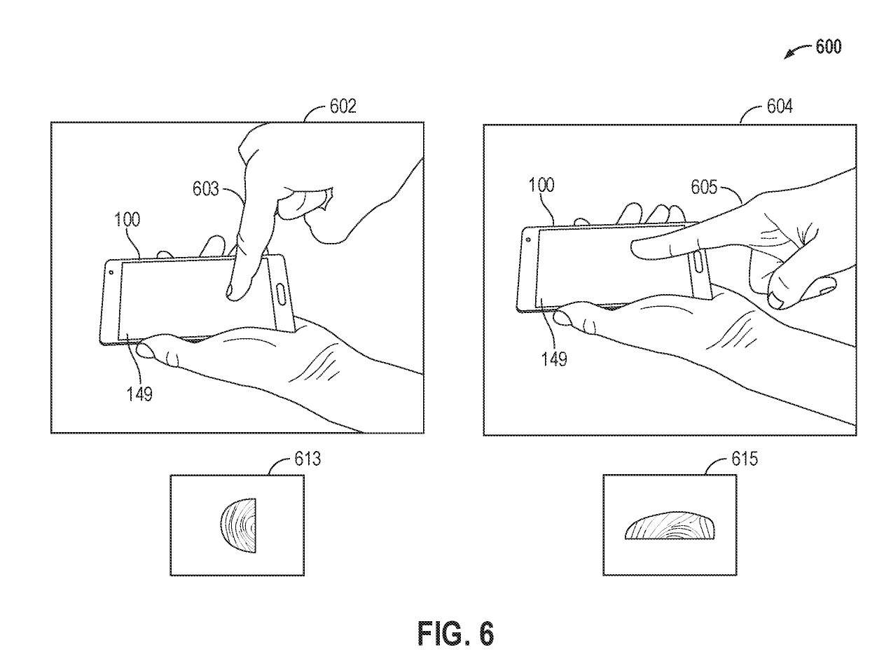

With reference to FIG. 6, an example 600, of a plurality of partial fingerprint scans in a particular time sequence using a single finger is described. At step 602, a first partial fingerprint scan is taken from the tip of a user's index finger 603 by sensor display 149 of device 100. Based upon this, a partial tip fingerprint scan (blob) 613 is received and fingerprint features are extracted and stored as a segment in the template. At step 604, a second partial fingerprint scan with a right roll is taken from user's index finger 605 by sensor display 149 of device 100. Based upon this, a partial fingerprint scan with a right roll (blob) 615 is received and fingerprint features are extracted and stored as a segment in the template. It should be appreciated that this plurality of partial fingerprint scans in a particular time sequence may be used as a user defined fingerprint password that is enrolled by the user and that may be used to authenticate the user to utilize an application or device—if the entered fingerprint password matches the stored fingerprint password from enrollment.

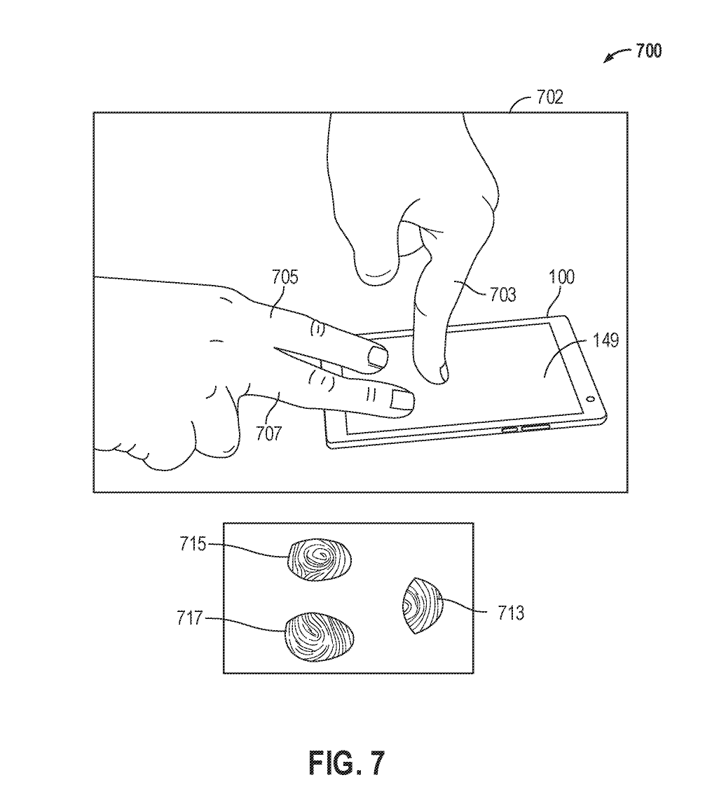

With additional reference to FIG. 7, an example 700, of a unique spatial configuration of simultaneously full and partial fingerprint scans from multiple fingers is described. At step 702: a partial tip fingerprint scan from an index finger 703 of one hand is taken by sensor display 149 of device 100; and full fingerprint scans from index finger 705 and middle finger 707 of the other hand of the user are taken by sensor display 149 of display 100. Based upon this, these simultaneous partial and full fingerprint scans (blobs) 713, 715, and 717, respectively, are received and for each blob fingerprint features are extracted and stored as a segment in the template. It should be appreciated that this plurality of partial and full fingerprint scans is a spatial configuration that may be used as a user defined fingerprint password that is enrolled by the user and that may be used to authenticate the user to utilize an application or device—if the entered fingerprint password matches the stored fingerprint password from enrollment. In the example of FIG. 7, the location and orientation of each of the fingerprints 713, 715, and 717 (i.e., full finger scans being next each other with the partial scan above and in the middle of the full scans) are significant in that they provide a very unique and strong biometric password.

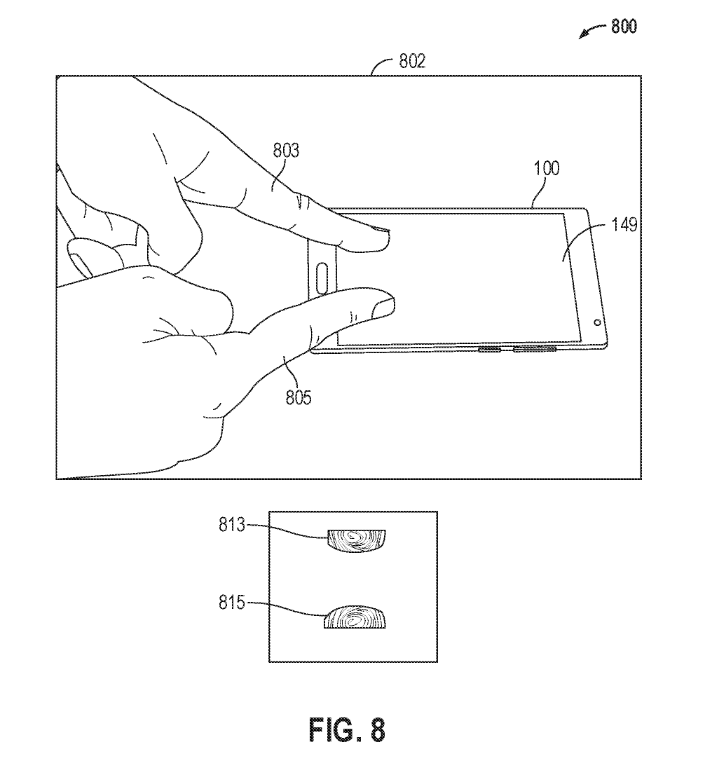

With additional reference to FIG. 8, an example 800, of a unique spatial configuration of simultaneous partial fingerprint scans from multiple fingers is described. At step 802: a partial left side fingerprint scan from an index finger 803 of one hand is taken by sensor display 149 of device 100; and a partial right side fingerprint scan from an index finger 805 of another hand is taken by sensor display 149 of device 100. Based upon this, these simultaneous partial side fingerprint scans (blobs) 813 and 815, respectively, are received and for each blob fingerprint features are extracted and stored as a segment in the template. It should be appreciated that this plurality of partial fingerprint scans is a spatial configuration that may be used as a user defined fingerprint password that is enrolled by the user and that may be used to authenticate the user to utilize an application or device—if the entered fingerprint password matches the stored fingerprint password from enrollment.

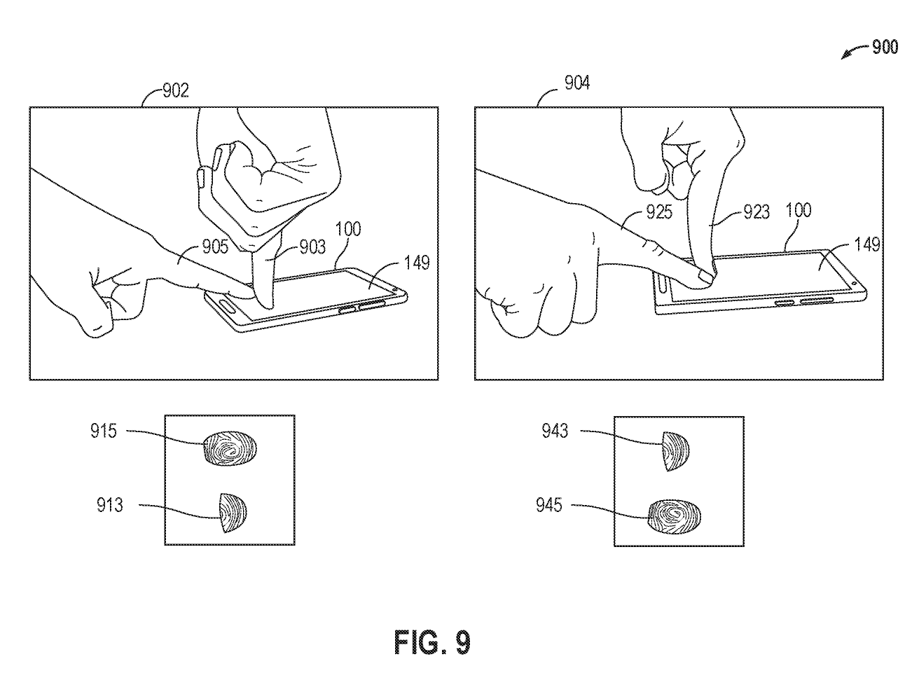

With additional reference to FIG. 9, an example 900, of multiple unique spatial configurations of simultaneous full and partial fingerprint scans from multiple fingers in a particular time sequence is described. At step 902: a partial tip fingerprint scan from an index finger 903 of one hand is taken by sensor display 149 of device 100; and a full fingerprint scan from an index finger 905 of another hand is taken by sensor display 149 of device 100. At step 904 (later in time): a partial tip fingerprint scan from an index finger 923 of one hand (e.g., the opposite hand of the previous partial tip fingerprint scan) is taken by sensor display 149 of device 100; and a full fingerprint scan from an index finger 925 of another hand (e.g., the opposite hand of the previous full fingerprint scan) is taken by sensor display 149 of device 100. Based upon this, a first set of a partial tip fingerprint scan and a full fingerprint scan (blobs) 913 and 915, respectively, are received and for each blob fingerprint features are extracted and stored as a segment in the template; and next, a second set of a partial tip fingerprint scan and a full fingerprint scan (blobs) 943 and 945, respectively, are received and for each blob fingerprint features are extracted and stored as a segment in the template. It should be appreciated that this plurality of partial and full fingerprint scans spatial configurations in a timed sequence may be used as a user defined fingerprint password that is enrolled by the user and that may be used to authenticate the user to utilize an application or device—if the entered fingerprint password matches the stored fingerprint password from enrollment. It should be appreciated that the fingerprint features from each blob previously described are for the most part unique but may overlap (e.g., with a full print).

As has been previously described, there are many different types of variations of full and/or partial fingerprint scans, different timing sequences, and spatial configurations that may be utilized as fingerprint passwords for authentication purposes. Further, as has been previously described fingerprint passwords may be separated spatially (e.g., spatial configurations) and separated by time (e.g., multiple individual full and/or partial fingerprint scans separated in time as well as spatial configurations separated in time), such that fingerprint passwords are provided that may be temporal and/or spatially defined that need to be matched in the exact same order for authentication providing a very strong authentication standard to authenticate applications and the use of devices.

It should be appreciated that some applications 145 may only require simple authentication (e.g., unlock the device 100), which may be accomplished with a simple sequence of multiple full fingerprints scans in a predefined order. On the other hand, some applications 145 (e.g., mobile banking) may require much higher security such as a unique spatial configuration or a combination of unique spatial configurations.

As an example, three different levels of password strength (low, medium, high) implemented through different fingerprint passwords may be utilized. For example, “Low” security: a user may scan a fingerprint three times with full fingerprint scan entries for enrollment and later authentication (e.g., FIG. 5). For example, “Medium” security: a user may utilize partial fingerprint scan entries in a time sequence to produce a unique combination by utilizing a same or multiple different fingers including tips and rolls for enrollment and later authentication (e.g., FIG. 6). For example, “High” security: a user may utilize a time sequence series of different unique spatial configurations of simultaneously full and/or partial fingerprint scans from multiple fingers for enrollment and later authentication to provide a very unique and detailed fingerprint password to provide a very strong authentication level. As an example, spatial configurations may be utilized for authentication utilizing whole or partial fingerprint scans as previously described in FIGS. 8 and 9.

In particular, spatial configurations may include parameters that include: Using fingers from one or two hands; Orientation—one finger on top and the other on the bottom or two fingers side-by-side; Angle—A) two finger tips, B) two finger pads, or C) combination of tip and pad; Combinations—multiple simultaneous partial scans and then full scans (e.g., two tips followed by two pads or some other combination).

As previously described, a wide variety of full and partial fingerprint scans from the same and/or different fingers in a variety of different sequences that may include rolls, angles, tips of the finger, sides of the finger and various simultaneous spatial configurations, provide a wide variety of different types of unique authentication fingerprint passwords. Further, as has been previously described, there are many different types of variations of full and/or partial fingerprint scans, different timing sequences, and spatial configurations that may be utilized as fingerprint passwords for authentication purposes. Moreover, as has been previously described fingerprint passwords may be separated spatially (e.g., spatial configurations) and separated by time (e.g., multiple individual full and/or partial fingerprint scans separated in time as well as spatial configurations separated in time), such that fingerprint passwords are provided that may be temporal and/or spatially defined that need to be matched in the exact same order for authentication providing a very strong authentication standard to authenticate applications and the use of devices.

Additionally, it should be appreciated that multiple successive scans of two or three or more gestures may allow for a biometric combination lock, which increases security because authentication is based upon user identification (biometric finger scans) and what the user knows (which two fingers and in which order). Further, as previously described, using various finger combinations allows for customization along with authentication. For example, launching a particular application 145 by using an index finger tip +middle finger tip side-by-side may allow for authentication to launch a camera application. Another combination, e.g., thumb-tip on bottom and index-tip on top could authenticate and launch a messaging application 145 (e.g., similar gesture to holding a pen).

Additionally, it should be appreciated that a combination lock concept may be extended to other biometric inputs. In this way, additional biometric inputs in combination with the fingerprint biometric input previously described may be utilized in tandem to provide increased authentication techniques. For example, biometric inputs such as face scans (e.g., from a camera sensor 149), iris scans (e.g., from an infrared camera sensor 149), eye sclera pattern scans (e.g., from a camera sensor 149), voice input (e.g., from a microphone sensor 149), hand scans from a touchscreen display, etc., may be utilized in addition to the previously described fingerprint scans. Further, it should be appreciated that as with the partial fingerprint scans, these other types of biometric inputs (e.g., face scans, iris scans, eye scans, hand scans, etc.) may likewise rely upon partial scans and combinations of partial scans.

For example, a house display screen as part of an access control device for a door of a house may utilize the previously described fingerprint password (full, partial, spatial combination, etc.) as well as an eye scan and/or combinations of partial fingerprint scans and partial eyes scans. Additional biometric inputs such as facial geometry (full and/or partial) and hand scans (full and/or partial) may be used. As another example, biometric inputs such as a partial scans of one or more portions of a face (e.g., left side of face, right side of face, forehead, eye, noise, mouth, etc.) in combination with a previously described fingerprint password (full, partial, spatial combination, etc.) may be utilized to authenticate an actor for a particular device operation. Accordingly, different biometric inputs (e.g., iris scan, hand scan, face scan, eye scan, etc.) may be utilized in addition to the previously described fingerprint password for authentication.

As has been described, embodiments may relate to a system and method for creating and using biometric combinations, such as, fingerprint passwords, in a particular temporal order and/or spatial configuration only know by the user, that can then be used to set multiple levels of security (e.g., low, medium, high, etc.) for a given application or system function. In particular, these types of fingerprint passwords may be based upon a unique temporal order of multiple, successive full/partial fingerprint scans only known by the user and/or based on unique spatial configurations of multiple, simultaneously full/partial fingerprints scans only known by the user. Further these biometric combinations may be assigned to applications or system functions based on the desired level of biometric security (e.g., low, medium, high, etc.). As previously described, this may be defined by the user upon enrollment and then may be used for authentication.

It should be appreciated that aspects of the previously described processes may be implemented in conjunction with the execution of instructions by a processor (e.g., processor 102) of devices (e.g., device 100), as previously described. Particularly, circuitry of the devices, including but not limited to processors, may operate under the control of a program, routine, or the execution of instructions to execute methods or processes in accordance with embodiments described (e.g., the processes and functions of FIGS. 2-9). For example, such a program may be implemented in firmware or software (e.g. stored in memory and/or other locations) and may be implemented by processors and/or other circuitry of the devices. Further, it should be appreciated that the terms device, SoC, processor, microprocessor, circuitry, controller, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, 5G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a WiFi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a secure processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A device to authenticate a user comprising:
a sensor; and
a processor coupled to the sensor, the processor configured to:
receive at least one fingerprint scan front the sensor inputted by the user during an enrollment process to define a fingerprint password, the at least one fingerprint scan including one or more full or partial fingerprint scans from a same finger or different fingers of the user, the full fingerprint scan including an angle or a roll, wherein the one or more full or partial fingerprint scans from the same finger or different fingers are set by the user to define the fingerprint password during the enrollment process; and
authenticate the user based upon the defined fingerprint password inputted through the sensor by the user.

2. The device of claim 1, wherein a full fingerprint scan includes a finger pad.

3. The device of claim 2, wherein a partial fingerprint scan includes at least one of a finger tip or a finger side.

4. The device of claim 3, wherein a partial fingerprint scan includes a roll or an angle of the fingerprint.

5. The device of claim 4, wherein the full or partial fingerprint scans from the same or different fingers to define the fingerprint password occur in a predefined order set by the user during the enrollment process.

6. The device of claim 4, wherein the full or partial fingerprint scans occur at a same time simultaneously to define a spatial configuration.

7. The device of claim 6, wherein multiple spatial configurations are set by the user during the enrollment process in a predefined order to define the fingerprint password.

8. The device of claim 1, wherein the sensor includes a display.

9. A method to authenticate a user comprising:
receiving at least one fingerprint scan from a sensor inputted by the user during an enrollment process to define a fingerprint password, the at least one fingerprint scan including one or more full or partial fingerprint scans from a same finger or different fingers of the user, the full fingerprint scan including an angle or a roll, wherein the one or more full or partial fingerprint scans front the same finger or different fingers are set by the user to define the fingerprint password during the enrollment process and
authenticating the user based upon the defined fingerprint password inputted through the sensor by the user.

10. The method of claim 9, wherein a full fingerprint scan includes a finger pad.

11. The method of claim 10, wherein a partial fingerprint scan includes at least one of a finger tip or a finger side.

12. The method of claim 11, wherein a partial fingerprint scan includes a roll or an angle of the fingerprint.

13. The method of claim 12, wherein the full or partial fingerprint scans from the same or different fingers to define the fingerprint password occur in a predefined order set by the user during the enrollment process.

14. The method of claim 12, wherein the full or partial fingerprint scans occur at a same time simultaneously to define a spatial configuration.

15. The method of claim 14, wherein multiple spatial configurations are set by the user during the enrollment process in a predefined order to define the fingerprint password.

16. The method of claim 9, wherein the sensor includes a display.

17. A non-transitory computer-readable medium including code to authenticate a user that, when executed by a processor, causes the processor to:
receive at least one fingerprint scan from a sensor inputted by the user during an enrollment process to define a fingerprint password, the at least one fingerprint scan including one or more full or partial fingerprint scans from a same finger or different fingers of the user, the full fingerprint scan including an angle or a roll, wherein the one or more full or partial fingerprint scans from the same finger or different fingers are set by the user to define the fingerprint password during the enrollment process; and
authenticate the user based upon the defined fingerprint password inputted through the sensor by the user.

18. The computer-readable medium of claim 17, wherein a full fingerprint scan includes a finger pad.

19. The computer-readable medium of claim 18, wherein a partial fingerprint scan includes at least one of a finger tip or a finger side.

20. The computer-readable medium of claim 19, wherein a partial fingerprint scan includes a roll or an angle of the fingerprint.

21. The computer-readable medium of claim 20, wherein the full or partial fingerprint scans from the same or different fingers to define the fingerprint password occur in a predefined order set by the user during the enrollment process.

22. The computer-readable medium of claim 20, wherein the full or partial fingerprint scans occur at a same time simultaneously to define a spatial configuration.

23. The computer-readable medium of claim 22, wherein multiple spatial configurations are set by the user during the enrollment process in a predefined order to define the fingerprint password.

24. The computer-readable medium of claim 17, wherein the sensor includes a display.

25. A device to authenticate a user comprising:
means for receiving at least one fingerprint scan from a sensor inputted by the user during an enrollment process to define a fingerprint password, the at least one fingerprint scan including one or more full or partial fingerprint scans from a same finger or different fingers of the user, the full fingerprint scan including an angle or a roll, wherein the one or more full or partial fingerprint scans from the same finger or different fingers are set by the user to define the fingerprint password during the enrollment process; and
means for authenticating the user based upon the defined fingerprint password inputted through the sensor by the user.

26. The device of claim 25, wherein a full fingerprint scan includes a finger pad.

27. The device of claim 26, wherein a partial fingerprint scan includes at least one of a finger tip or a finger side.

28. The device of claim 27, wherein a partial fingerprint scan includes a roll or an angle of the fingerprint.

29. The device of claim 28, wherein the full or partial fingerprint scans from the same or different fingers to define the fingerprint password occur in a predefined order set by the user during the enrollment process.

30. The device of claim 28, wherein the full or partial fingerprint scans occur at a same time simultaneously to define a spatial configuration.
